(19) United States
(12) Patent Application Publication
(10) Pub. No.: US 2004/0073837 A1
(43) Pub. Date: Apr. 15, 2004

(54) Semiconductor device and in-circuit emulator using the same

(76) Inventors: Masahiko Mizuta, Sappovo-shi (JP); Yoshimi Oka, Kitahiroshima-city (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/649,153

(22) Filed: Aug. 27, 2003

(30) Foreign Application Priority Data
Aug. 27, 2002 (JP) 2002-246228

(51) Int. Cl. H04L 1/22; H02H 3/05

(52) U.S. Cl. 714/28

(57) ABSTRACT

A semiconductor device in which internal data, programs or program instructions can be read when a predetermined data or signal is inputted. It is equipped with protect circuits 31-34 that are connected between a CPU 11, and ROM 21, a RAM 22, a register 23 and a user circuit 24, respectively; a debug circuit 12 that, when connected to a debug tool 40, controls the CPU 11 and instructs the protect circuits 31-34 not to transfer data, and a protect release circuit 13 that, upon receiving a predetermined signal, instructs the protect circuits 31-34 to transfer data without regard to an instruction from the debug circuit 12. The CPU 11 executes predetermined operations when it is not connected to the debug tool 40.

### BACKGROUND OF THE INVENTION

1. Field of the Invention

The present invention relates to a semiconductor device that, when connected to an external debug tool, transmits internal data or program instructions to the debug tool. Furthermore, the present invention relates to an in-circuit emulator that uses such a semiconductor device.

2. Description of the Related Art

Debug circuits may be mounted on semiconductor devices such as single-chip microcomputers and system LSI (Large Scale Integrated circuits) that are custom products made according to a user's specifications in order to facilitate debugging of mainly software (programs). When a semiconductor device with such a debug circuit mounted thereon is connected to an external debug tool, contents (data or programs) in ROM (Read Only Memory), RAM (Random Access Memory) and registers within the semiconductor device are transmitted to the debug tool. A user who debugs the software can be informed of the contents in the ROM, RAM and registers within the semiconductor device through the debug tool, and can readily debug the software.

Some semiconductor devices may internally contain data or programs that should not be disclosed to individuals (hereafter referred to as “third parties”) other than the user who debugs the software. For example, there are cases where a ROM within a semiconductor device stores a release key to release a specified code, and the release key is not desired to be disclosed to a third person.

In such a case, some countermeasures can be taken to prevent data in the semiconductor device from being disclosed to a third party. These include, for example, (i) not mounting a debug circuit on the semiconductor device, or (ii) when a debug circuit is mounted on the semiconductor device, not publicly disclosing the method to use the debug circuit.

However, according to the countermeasure (i), the user who performs debugging of the software cannot obtain internal data of the semiconductor device, which makes the debugging of the software difficult.

Also, according to the countermeasure (ii), when a third party finds out the method to use the debug circuit by analyzing the semiconductor device, the internal data of the semiconductor device would be disclosed to the third party.

It is noted that Japanese Laid-open patent publication (TOKKAI) HEI 10-133906 (hereafter referred to also as “Document 1”) describes an in-circuit emulator which, when emulating a microcomputer having a memory space that is divided into a program memory region for storing programs and a data memory region for storing data, and address buses corresponding to the respective regions, sets in advance mapping data indicative of attributes of mapping regions mapped within the program memory region and protect data indicative of permission or disapproval of accesses to special function registers allocated within the data memory region, and detects illegal accesses to the mapping regions and special function registers to stop the emulation. The in-circuit emulator comprises a selection means that receives inputs of bus signals on each of the address buses, and selects and outputs one of the bus signals by using a control signal, and a storage means that performs an address input of the bus signal outputted from the selection means, and sets up and stores in advance the mapping data and the protect data.

However, the in-circuit emulator described in Document 1 sets in advance mapping data indicative of attributes of mapping regions mapped within the program memory region and protect data indicative of permission/disapproval of accesses to special function registers allocated within the data memory region, is equipped with the selection means that receives inputs of bus signals on the address buses corresponding respectively to the program memory region and the data memory region and selects one of the bus signals by using a control signal, and the storage means that performs an address input of the bus signal output of the selection means and sets up and stores in advance the mapping data and the protect data, and detects illegal accesses to the mapping regions and the special function registers to thereby stop the emulation, to thereby integrate a mapping memory and an SFR protection memory into a single protect memory; but it is not intended to enable the user who performs a debugging of software to read data or the like in a semiconductor device and prevent a third party from reading data of the like in the semiconductor device.

Also, a TOKKAI 2000-347942 (hereafter referred to also as “Document 2”) describes an information processing apparatus that is characterized in comprising a memory that stores information protected from illegal accesses from an emulator externally provided, including as stored information a security release program which consists of a user program that can be set up individually by the user, an on-chip debug circuit to be connected to the emulator to control input and output of signals necessary for debugging between the emulator and an information processing device to support debugging of the information processing device, and a security circuit that, upon receiving a power-on reset signal that resets the information processing device at the time of power on, invalidates the function of the on-chip debug circuit to set up a security and prohibits reading of the information stored in the memory by the emulator, and that, upon receiving a security designation bit and an enable code to enable resetting of the security designation bit, validates the function of the on-chip debug circuit to release the security and enables reading of the information stored in the memory by the emulator.

However, although the information processing device described in Document 2 may protect the information stored in the memory from illegal access by the emulator provided outside, its stored information includes a security release program composed of a user program that can be set up individually by the user.

### OBJECTS OF THE INVENTION

In view of the above, an object of the present invention is to provide a semiconductor device in which internal data and programs can be read, when it is connected to a debug tool, and a predetermined data or signal is inputted. Furthermore, another object of the present invention is to provide an in-circuit emulator that is equipped with such a semiconductor device.

### SUMMARY OF THE INVENTION

To solve the problems described above, a semiconductor device in accordance with the present invention pertains to a semiconductor device that is equipped with an operation processing circuit and M number (M is a natural number) of functional blocks having predetermined functions, and that, when connected to an external debug tool, sends data, programs or program instructions in the functional blocks to the debug tool, the semiconductor device comprising: N number of first circuits that are respectively connected between a predetermined N number (N is a natural number smaller than M) of the functional blocks among the M number of functional blocks and the operation processing circuit, and that, in response to an instruction, transfer data, programs or program instructions between the N number of the functional blocks and the operation processing circuit; a second circuit that, when connected to the debug tool, controls the operation processing circuit in response to an instruction from the debug tool, and instructs the N number of the first circuits not to transfer data or program between the N number of the functional blocks and the operation processing circuit; and a third circuit that, upon receiving predetermined data or signal, instructs the N number of the first circuits according to the data or signal to transfer data, programs or program instructions between the functional blocks and the operation processing circuit regardless of an instruction from the second circuit, wherein the operation processing circuit, when not connected to the debug tool, transfers and receives data or program to and from the M number of the functional blocks to execute predetermined operations, and when connected to the debug tool, reads and transfers to the debug tool data, programs or program instructions in the N number of the function block through the N number of the first circuits.

In one aspect, the third circuit may receive a plurality of data or signals, and instruct particular ones of the N number of the first circuits according to the plurality of data or signals to transfer data, programs or program instructions between the functional blocks and the operation processing circuit, regardless of an instruction from the second circuit.

Also, the third circuit may receive encoded data or signals, decodes the encoded data or signals, and instruct particular ones of the N number of the first circuits according to the decoded data or signals to transfer data, programs or program instructions between the functional blocks and the operation processing circuit, regardless of an instruction from the second circuit.

Also, the third circuit may include a register, and, when the register is accessed, may instruct the N number of the first circuits to transfer data, programs or program instructions between the functional blocks and the operation processing circuit, regardless of an instruction from the second circuit.

Furthermore, the third circuit may include a register, and, when predetermined data is written in the register, may instruct particular ones of the N number of the first circuits according to the data written in the register to transfer data, programs or program instructions between the functional blocks and the operation processing circuit, regardless of an instruction from the second circuit.

Also, the third circuit may include a plurality of registers, and, when the registers are accessed, may instruct particular ones of the N number of the first circuits according to the registers accessed to transfer data, programs or program instructions between the functional blocks and the operation processing circuit, regardless of an instruction from the second circuit.

Furthermore, the third circuit may include a plurality of registers, and, when predetermined data is written in any or all of the registers, may instruct particular ones of the first circuits among the N number of the first circuits according to the registers accessed or the data written in the registers to transfer data, programs or program instructions between the functional blocks and the operation processing circuit, regardless of an instruction from the second circuit.

Also, the predetermined data or signal may be supplied from the operation processing circuit or from outside. Or, the register may be accessed from the operation processing circuit or from outside.

Also, the semiconductor device may be further equipped with a fourth circuit that receives data in a predetermined protocol from outside, wherein the fourth circuit may output data or signal to the third circuit based on data received from outside.

Also, an in-circuit emulator in accordance with the present invention is equipped with a semiconductor device according to the present invention, and a debug tool that is connected to the operation processing circuit and the second circuit within the semiconductor device.

By the invention with the structure described above, when a predetermined data or signal is inputted, internal data or programs can be read. As a result, reading of internal data by the user who performs debugging of the software and preventing other users from reading the internal data can be readily realized.

### BRIEF DESCRIPTION OF THE DRAWINGS

FIG. 1 shows an in-circuit emulator in accordance with a first embodiment of the present invention.

FIG. 2 shows an internal structure of the protect circuit in FIG. 1.

FIG. 3 shows an internal structure of the input/output (I/O) buffer shown in FIG. 2.

FIG. 4 is a truth table expressing operations of the buffers shown in FIG. 3.

FIG. 5 shows an in-circuit emulator in accordance with a second embodiment of the present invention.

FIG. 6 shows an in-circuit emulator in accordance with a third embodiment of the present invention.

FIG. 7 shows another example of an internal structure of the input/output (I/O) buffer shown in FIG. 2.

FIG. 8 shows another example of an internal structure of the input/output (I/O) buffer shown in FIG. 2.

FIG. 9 shows another example of an internal structure of the input/output (I/O) buffer shown in FIG. 2.

### DESCRIPTION OF THE PREFERRED EMBODIMENTS

An embodiment of the present invention will be described with reference to the accompanying drawings. It is noted that like components are assigned the same reference numbers, and their description is not repeated.

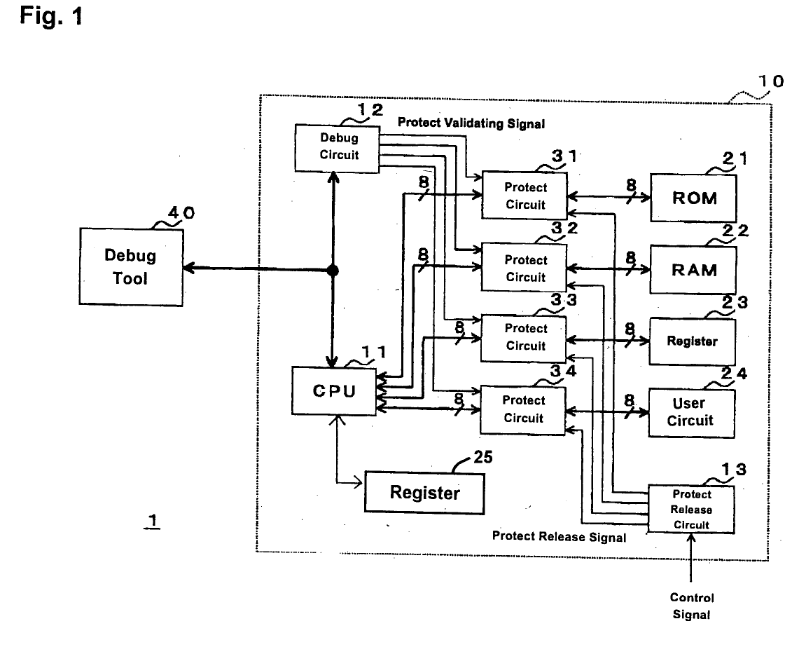

FIG. 1 shows an in-circuit emulator in accordance with an embodiment of the present invention. As indicated in FIG. 1, an in-circuit emulator 1 is equipped with a system LSI (Large Scale Integrated circuit) 10 and a debug tool 40.

The system LSI 10 includes a CPU (Central Processing Unit) 11, a debug circuit 12, a protect release circuit 13, a ROM (Read Only Memory) 21, a RAM (Random Access Memory) 22, registers 23, 25, a user circuit 24, and protect circuits 31-34.

The ROM 21 stores software (programs) executed by the CPU 11, and data used by the CPU 11. The RAM 22 and the register 23 store temporary data or the like. The user circuit 24 performs operations that meet the user's specification.

The CPU 11, when it is not connected to the debug tool 40, executes predetermined operations through reading internal data or programs stored in the ROM 21, the RAM 22, the register 23 or the user circuit 24. Also, when connected to the debug tool 40, the CPU 11 reads internal data stored in the ROM 21, the RAM 22, the register 23 or the user circuit 24 according to instructions of the debug tool 40 and the debug circuit 12, and outputs the data to the debug tool 40. In the present embodiment, the CPU 11 is connected to the debug tool 40, and therefore reads internal data stored in the ROM 21, the RAM 22, the register 23 or the user circuit 24 according to instructions of the debug tool 40 and the debug circuit 12, and outputs the data to the debug tool 40.

The protect circuits 31-34 are connected between the CPU 11 and each of the ROM 21, the RAM 22, the register 23, and the user circuit 24, respectively, and transfer data or programs between the ROM 21, the RAM 22, the register 23 or the user circuit 24 and the CPU 11, according to instructions from the debug circuit 12 or the protect release circuit 13.

The CPU 11 and the protect circuits 31-34, and the CPU 11 and the register 25, and the protect circuits 31-34 and the ROM 21, the RAM 22, the register 23 and the user circuit 24 are connected with 8-bit buses, respectively.

The debug circuit 12, when it is connected to the debug tool 40, controls the CPU 11 according to instructions of the debug tool 40, outputs a high-level protect validating signal to the protect circuits 31-34, and, when it is not connected to the debug tool 40, outputs a low-level protect validating signal to the protect circuits 31-34 . In the present embodiment, the debug circuit 12 is connected to the debug tool 40, and therefore outputs a high-level protect validating signal to the protect circuits 31-34.

Control signals are input from outside to the protect release circuit 13. When a control signal externally inputted is at a low level, the protect release circuit 13 outputs a low-level protect release signal to the protect circuits 31-34. When a control signal externally inputted is at a high level, the protect release circuit 13 outputs a high-level protect release signal to the protect circuits 31-34. It is noted-that the control signal is inputted from a terminal that is described as “unused” or “reserved” in a technical manual describing the system LSI 10.

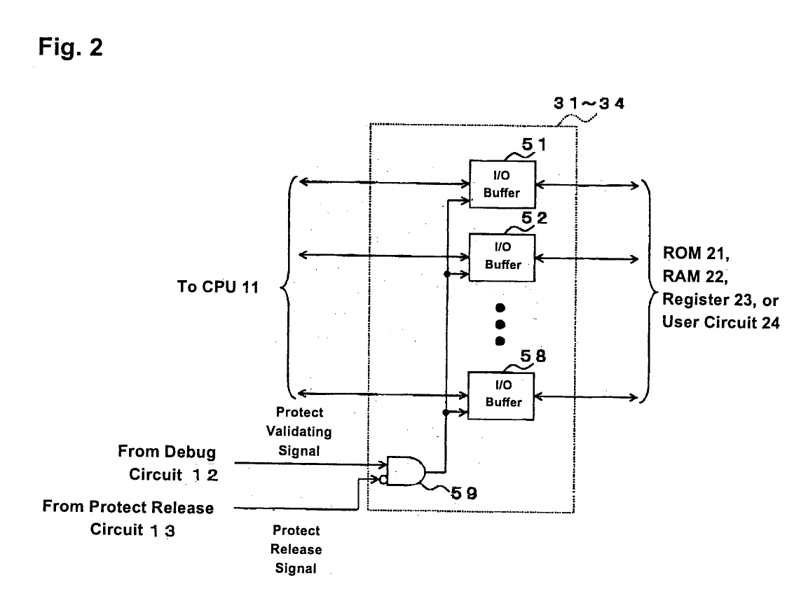

FIG. 2 shows an internal structure of each of the protect circuits 31-34. As indicated in FIG. 2, each of the protect circuits 31-34 includes input/output buffers 51-58 and an AND gate 59.

The AND gate 59 calculates a logical product of a protect validating signal and a signal that is provided by inverting a protect release signal, and outputs the resultant signal to the input/output buffers 51-58.

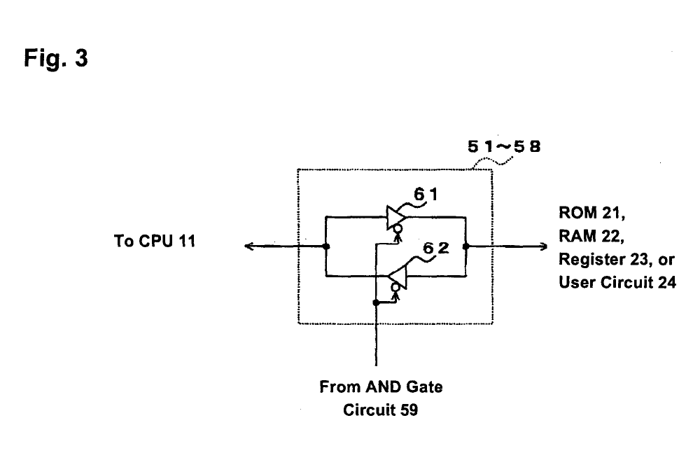

FIG. 3 shows an internal structure of each of the input/output buffers 51-58. As indicated in FIG. 3, each of the input/output buffers 51-58 includes buffers 61 and 62 with an output enable function. The buffer 61 has its input connected to the CPU 11, and its output connected to either the ROM 21, the RAM 22, the register 23 or the user circuit 24. Also, the buffer 62 has its input connected to an output of the buffer 61, and its output connected to an input of the buffer 61.

The buffers 61 and 62 turn on when the output signal of the AND gate circuit 59 is at a low level, and turn off when the output signal of the AND gate circuit 59 is at a high level.

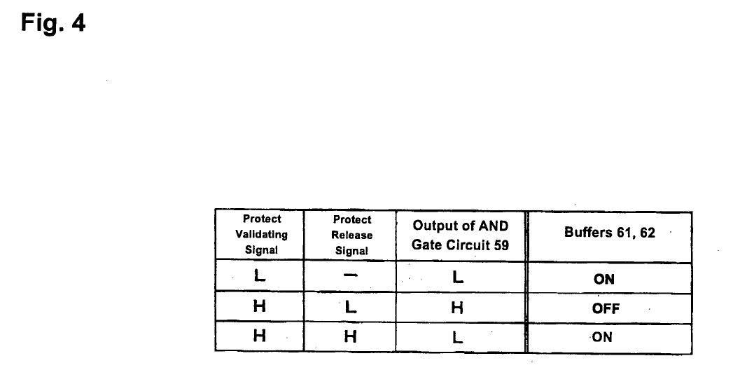

FIG. 4 is a truth table expressing operations of the buffers 61 and 62. As indicated in FIG. 4, when a protect validating signal is at a low level, the output signal of the AND gate circuit 59 becomes low level regardless of whether the protect release signal is at a high level or a low level, such that the buffers 61 and 62 turn on.

When the protect validating signal is at a high level, and the protect release signal is at a low level, the output signal of the AND gate circuit 59 becomes high level, such that the buffers 61 and 62 turn off.

In this manner, by the in-circuit emulator 1, when a high-level control signal is inputted in the protect release circuit 13, the buffers 61 and 62 in the protect circuits 31-34 turn on, such that the CPU 11 can read data and the like in the ROM 21, the RAM 22, the register 23 and the user circuit 24, and send them to the debug tool 40. As a result, the user can read the data or the like in the ROM 21, the RAM 22, the register 23 and the user circuit 24. When a low-level control signal is inputted in the protect release circuit 13, the buffers 61 and 62 in the protect circuits 31-34 turn off, such that the CPU 11 cannot read data or the like in the ROM 21, the RAM 22, the register 23 and the user circuit 24. As a result, the user is prevented from reading data or the like in the ROM 21, the RAM 22, the register 23 and the user circuit 24.

On the other hand, the CPU 11 can read data or the like in the register 25 independent of the protect validating signal and the protect release signal because it is directly connected thereto.

Terminals for inputting control signals in the system LSI 10 (i.e., terminals that are described as “unused” or “reserved” in a technical manual) may be made known only to users who are authorized to read data and the like stored in the ROM 21, the RAM 22, the register 23 and the user circuit 24 (for, example, engineers who perform debugging of software), and may not be made known to those other than the authorized users. By so doing, users who are authorized to read data and the like in the ROM 21, the RAM 22, the register 23 and the user circuit 24 can readily perform debugging, and other users are prevented from reading data or the like in the ROM 21, the RAM 22, the register 23 and the user circuit 24.

Also, because the terminals for inputting control signals in the system LSI 10 are described as “unused” or “reserved” in a technical manual, it is difficult for users who are not informed of the terminals to input control signals to analyze the system LSI 10 because the buffers 61 and 62 are turned off when the system LSI 10 is connected to the debug tool 40. Accordingly, when the system LSI 10 is connected to the debug tool 40, it would become very difficult for users who are not informed of the terminals to input control signals to read data or the like in the ROM 21, the RAM 22, the register 23 and the user circuit 24.

Also, when the system LSI 10 is connected to the debug tool 40, there is no alternative way to turn on the buffers 61 and 62 other than inputting a high-level control signal in the protect release circuit 13, such that it is not possible to read data or the like in the ROM 21, the RAM 22, the register 23 and the user circuit 24 by using another method or apparatus.

In the present embodiment, when a single control signal is at a high level, the buffers 61 and 62 in the protect circuits 31-34 turn on. However, for example, first-fourth control signals may be inputted, and it may be structured such that when the first control signal is at a high level, the buffers 61 and 62 within the protect circuit 31 turn on; when the second control signal is at a high level, the buffers 61 and 62 within the protect circuit 32 turn on; when the third control signal is at a high level, the buffers 61 and 62 within the protect circuit 33 turn on; and when the fourth control signal is at a high level, the buffers 61 and 62 within the protect circuit 34 turn on. By this, security levels can be set for reading data or the like in the ROM 21, the RAM 22, the register 23 and the user circuit 24, and the data reading according to the security levels can be realized.

Furthermore, the first-fourth control signals may be encoded, and the protect release circuit 13 may decode the first-fourth control signals. According to the decoded result, the buffers 61 and 62 in any or all of the protect circuits 31-34 may turn on.

Also, the protect release circuit 13 may internally include a register; and when the register is accessed from outside, a high-level protect release signal may be outputted.

Furthermore, the protect release circuit 13 may internally include a register; and when data having a predetermined value (i.e., a release key) is written in the register from outside, the buffers 61 and 62 in any or all of the protect circuits 31-34 may turn on according to the data written. By this, security levels can be set for reading data or the like in the ROM 21, the RAM 22, the register 23 and the user circuit 24, and the data reading according to the security levels can be realized.

Also, the protect release circuit 13 may internally include a plurality of registers; and when any of the registers are accessed from outside, the buffers 61 and 62 in any or all of the protect circuits 31-34 may turn on according to the registers accessed. By this, security levels can be set for reading data or the like in the ROM 21, the RAM 22, the register 23 and the user circuit 24, and the data reading according to the security levels can be realized.

Furthermore, the protect release circuit 13 may internally include a plurality of registers; and when data having a predetermined value (i.e., a release key) is written in any of the registers from outside, the buffers 61 and 62 in any or all of the protect circuits 31-34 may turn on according to the registers written or data written. By this, security levels can be set for reading data or the like in the ROM 21, the RAM 22, the register 23 and the user circuit 24, and the data reading according to the security levels can be realized.

Also, in the present embodiment, the protect circuits 31-34 are connected between the ROM 21, RAM 22, register 23 and user circuit 24 and the CPU 11. However, for example, when reading of only the data or the like in the ROM 21 is to be prevented, the protect circuit 31 may be connected between the ROM 21 and the CPU 11, and the other protect circuits 32 - 34 may not be required.

It is noted that when the system LSI 10 is not connected to the debug tool 40, the CPU 11 can execute predetermined operation processing.

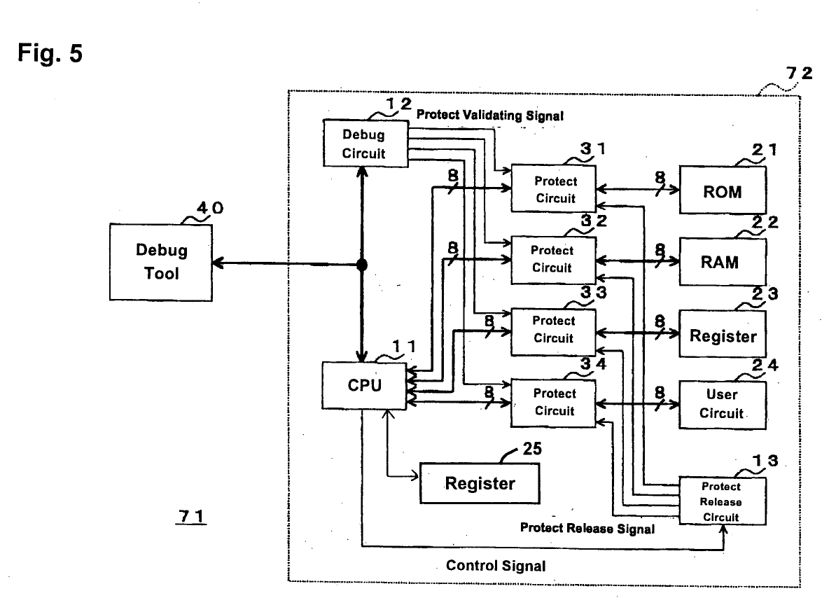

Next, a second embodiment of the present invention will be described. FIG. 5 shows an in-circuit emulator in accordance with the second embodiment of the present invention.

As indicated in FIG. 5, the in-circuit emulator 71 is equipped with a system LSI 72 and a debug tool 40.

The system LSI 72 includes a CPU 11, a debug circuit 12, a protect release circuit 13, a ROM 21, a RAM 22, registers 23, 25, a user circuit 24, and protect circuits 31-34.

The CPU 11, when it is not connected to the debug tool 40, executes predetermined operations through reading internal data or programs stored- in the ROM 21, the RAM 22, the register 23 or the user circuit 24. Also, the CPU 11, when it is connected to the debug tool 40, outputs a high-level or low-level control signal to the protect release circuit 13 according to an instruction of the debug tool 40 and the debug circuit 12. In the present embodiment, the CPU 11 is connected to the debug tool 40, the CPU 11 outputs a high-level or low-level control signal to the protect release circuit 13 according to an instruction of the debug tool 40 and the debug circuit 12.

A control signal is inputted in the protect release circuit 13 from the CPU 11. When the control signal is at a low level, the protect release circuit 13 outputs a low-level protect release signal to the protect circuits 31-34. Alternatively, when the control signal is at a high level, the protect release circuit 13 outputs a high-level protect release signal to the protect circuits 31-34.

In this manner, by the in-circuit emulator 71, when the CPU 11 outputs a high-level control signal to the protect release circuit 13 according to an instruction by the debug tool 40 or the debug circuit 12, the buffers 61 and 62 in the protect circuits 31-34 turn on, such that the CPU 11 can read data and the like in the ROM 21, the RAM 22, the register 23 and the user circuit 24, and send them to the debug tool 40. As a result, the user can read the data or the like in the ROM 21, the RAM 22, the register 23 and the user circuit 24. On the other hand, when the CPU 11 outputs a low-level control signal to the protect release circuit 13 according to an instruction by the debug tool 40 or the debug circuit 12, the buffers 61 and 62 in the protect circuits 31-34 turn off, such that the CPU 11 cannot read data or the like in the ROM 21, the RAM 22, the register 23 and the user circuit 24. As a result, the user is prevented from reading data or the like in the ROM 21, the RAM 22, the register 23 and the user circuit 24.

A command or the like that makes the CPU 11 output a high-level control signal may be informed only to users who are authorized to read data and the like in the ROM 21, the RAM 22, the register 23 and the user circuit 24 (for, example, engineers who perform debugging of software), and may not be made known to those other than the authorized users.

By so doing, users who are authorized to read data and the like in the ROM 21, the RAM 22, the register 23 and the user circuit 24 can readily perform debugging, and other users are prevented from reading data or the like in the ROM 21, the RAM 22, the register 23 and the user circuit 24.

On the other hand, the CPU 11 can read data or the like in the register 25 independent of the protect validating signal and the protect release signal.

Also, it is difficult for users, who are not informed of the command or the like for making the CPU 11 to output a high-level control signal, to analyze the system LSI 72 because the buffers 61 and 62 are turned off when the system LSI 72 is connected to the debug tool 40.

Accordingly, when the system LSI 72 is connected to the debug tool 40, it would become very difficult for users, who are not informed of the command or the like for making the CPU 11 to output a high-level control signal, to read data or the like in the ROM 21, the RAM 22, the register 23 and the user circuit 24.

Also, when the system LSI 72 is connected to the debug tool 40, there is no alternative way to turn on the buffers 61 and 62 other than making the CPU 11 to output a high-level control signal, such that it is not possible to read data or the like in the ROM 21, the RAM 22, the register 23 and the user circuit 24 by using another method or apparatus.

In the present embodiment, when a single control signal is at a high level, the buffers 61 and 62 in the protect circuits 31-34 turn on. However, for example, the CPU 11 may output first-fourth control signals to the protect release circuit 13, and it may be structured such that when the first control signal is at a high level, the buffers 61 and 62 within the protect circuit 31 turn on; when the second control signal is at a high level, the buffers 61 and 62 within the protect circuit 32 turn on; when the third control signal is at a high level, the buffers 61 and 62 within the protect circuit 33 turn on; and when the fourth control signal is at a high level, the buffers 61 and 62 within the protect circuit 34 turn on. By this, security levels can be set for reading data or the like in the ROM 21, the RAM 22, the register 23 and the user circuit 24, and the data reading according to the security levels can be realized.

Furthermore, the first-fourth control signals may be encoded, and the protect release circuit 13 may decode the first-fourth control signals. According to the decoded result, the buffers 61 and 62 in any or all of the protect circuits 31-34 may turn on.

Also, the protect release circuit 13 may internally include a register; and when the register is accessed by the CPU 11, a high-level protect release signal may be outputted.

Furthermore, the protect release circuit 13 may internally include a register; and when data having a predetermined value (i.e., a release key) is written in the register from the CPU 11, the buffers 61 and 62 in any or all of the protect circuits 31-34 may turn on according to the data written. By this, security levels can be set for reading data or the like stored in the ROM 21, the RAM 22, the register 23 and the user circuit 24, and the data reading according to the security levels can be realized.

Also, the protect release circuit 13 may internally include a plurality of registers; and when any of the registers are accessed from CPU 11, the buffers 61 and 62 in any or all of the protect circuits 31-34 may turn on according to the registers accessed. By this, security levels can be set for reading data or the like stored in the ROM 21, the RAM 22, the register 23 and the user circuit 24, and the data reading according to the security levels can be realized.

Furthermore, the protect release circuit 13 may internally include a plurality of registers; and when data having a predetermined value (i.e., a release key) is written in any of the registers from the CPU 11, the buffers 61 and 62 in any or all of the protect circuits 31-34 may turn on according to the registers written or data written. By this, security levels can be set for reading data or the like stored in the ROM 21, the RAM 22, the register 23 and the user circuit 24, and the data reading according to the security levels can be realized.

Also, in the present embodiment, the protect circuits 31-34 are connected between the ROM 21, RAM 22, register 23 and user circuit 24 and the CPU 11. However, for example, when reading of only the data or the like in the ROM 21 is to be prevented, the protect circuit 31 may be connected between the ROM 21 and the CPU 11, and the other protect circuits 32 - 34 may not be required.

Also, in the in-circuit emulator 71, control signals do not need to be inputted in the protect release circuit 13 from outside like the in-circuit emulator 1, such that terminals for inputting control signals or special devices for inputting control signals are not required.

It is noted that when the system LSI 72 is not connected to the debug tool 40, the CUP 11 can execute predetermined operation processing.

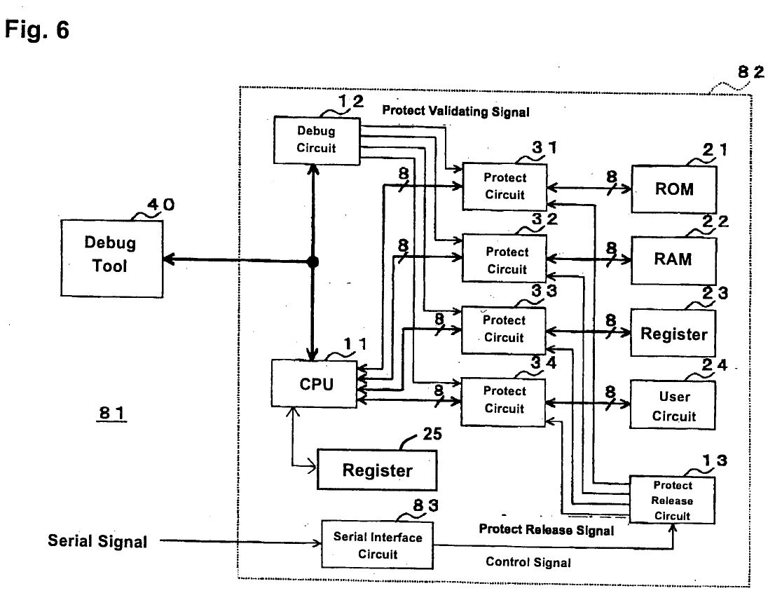

Next, a third embodiment of the present invention will be described. FIG. 6 shows an in-circuit emulator in accordance with the second embodiment of the present invention.

As indicated in FIG. 6, the in-circuit emulator 81 is equipped with a system LSI 82 and a debug tool 40.

The system LSI 82 includes a CPU 11, a debug circuit 12, a protect release circuit 13, a ROM 21, a RAM 22, registers 23, 25, a user circuit 24, protect circuits 31-34, and a serial interface circuit 83.

The serial interface circuit 83 receives a serial signal in a predetermined protocol from outside, and outputs a high-level or a low-level control signal to the protect release circuit 13 based on the serial signal.

A control signal is inputted in the protect release circuit 13 from the serial interface circuit 83. When the control signal is at a low level, the protect release circuit 13 outputs a low-level protect release signal to the protect circuits 31-34. Alternatively, when the control signal is at a high level, the protect release circuit 13 outputs a high-level protect release signal to the protect circuits 31-34.

In this manner, by the in-circuit emulator 81, when the serial interface circuit 83 outputs a high-level control signal to the protect release circuit 13 according to a serial signal inputted from outside, the buffers 61 and 62 in the protect circuits 31-34 turn on, such that the CPU 11 can read data and the like in the ROM 21, the RAM 22, the register 23 and the user circuit 24, and send them to the debug tool 40. As a result, the user can read the data or the like in the ROM 21, the RAM 22, the register 23 and the user circuit 24. On the other hand, when the serial interface circuit 83 outputs a low-level control signal to the protect release circuit 13 according to a serial signal inputted from outside, the buffers 61 and 62 in the protect circuits 31-34 turn off, such that the CPU 11 cannot read data or the like in the ROM 21, the RAM 22, the register 23 and the user circuit 24. As a result, the user is prevented from reading data or the like in the ROM 21, the RAM 22, the register 23 and the user circuit 24.

A serial signal and protocol for causing the serial interface circuit 83 to output a high-level control signal may be made known only to users who are authorized to read data and the like stored in the ROM 21, the RAM 22, the register 23 and the user circuit 24 (for, example, engineers who perform debugging of software), and may not be made known to those other than the authorized users. By so doing, users who are authorized to read data and the like in the ROM 21, the RAM 22, the register 23 and the user circuit 24 can readily perform debugging, and other users are prevented from reading data or the like in the ROM 21, the RAM 22, the register 23 and the user circuit 24.

On the other hand, the CPU 11 can read data or the like in the register 25 independent of the protect validating signal and the protect release signal.

Also, it is difficult for users, who are not informed of the serial signal and protocol for making the serial interface circuit 83 to output a high-level control signal, to analyze the system LSI 82 because the buffers 61 and 62 are turned off when the system LSI 82 is connected to the debug tool 40.

Accordingly, when the system LSI 82 is connected to the debug tool 40, it would become very difficult for users, who are not informed of the serial signal for making the serial interface circuit 83 to output a high-level control signal, to read data or the like in the ROM 21, the RAM 22, the register 23 and the user circuit 24.

Also, when the system LSI 82 is connected to the debug tool 40, there is no alternative way to turn on the buffers 61 and 62 other than making the serial interface circuit 83 to output a high-level control signal, such that it is not possible to read data or the like in the ROM 21, the RAM 22, the register 23 and the user circuit 24 by using another method or apparatus.

In the present embodiment, when a single control signal is at a high level, the buffers 61 and 62 in the protect circuits 31-34 turn on. However, for example, the serial interface circuit 83 may output first-fourth control signals to the protect release circuit 13, and it may be structured such that when the first control signal is at a high level, the buffers 61 and 62 within the protect circuit 31 turn on; when the second control signal is at a high level, the buffers 61 and 62 within the protect circuit 32 turn on; when the third control signal is at a high level, the buffers 61 and 62 within the protect circuit 33 turn on; and when the fourth control signal is at a high level, the buffers 61 and 62 within the protect circuit 34 turn on. By this, security levels can be set for reading data or the like stored in the ROM 21, the RAM 22, the register 23 and the user circuit 24, and the data reading according to the security levels can be realized.

Furthermore, the first-fourth control signals may be encoded, and the protect release circuit 13 may decode the first-fourth control signals. According to the decoded result, the buffers 61 and 62 in any or all of the protect circuits 31-34 may turn on. By this, security levels can be set for reading data or the like stored in the ROM 21, the RAM 22, the register 23 and the user circuit 24, and the data reading according to the security levels can be realized.

In the present embodiment, the serial interface circuit 83 is used. However, a parallel interface circuit may be used.

Also, in the present embodiment, the protect circuits 31-34 are connected between the ROM 21, RAM 22, register 23 and user circuit 24 and the CPU 11. However, for example, when reading of only the data or the like in the ROM 21 is to be prevented, the protect circuit 31 may be connected between the ROM 21 and the CPU 11, and the other protect circuits 32 - 34 may not be required.

It is noted that when the system LSI 82 is not connected to the debug tool 40, the CPU 11 can execute predetermined operation processing.

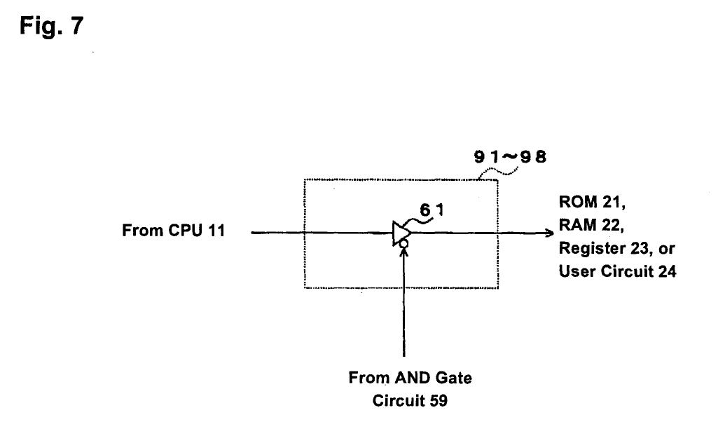

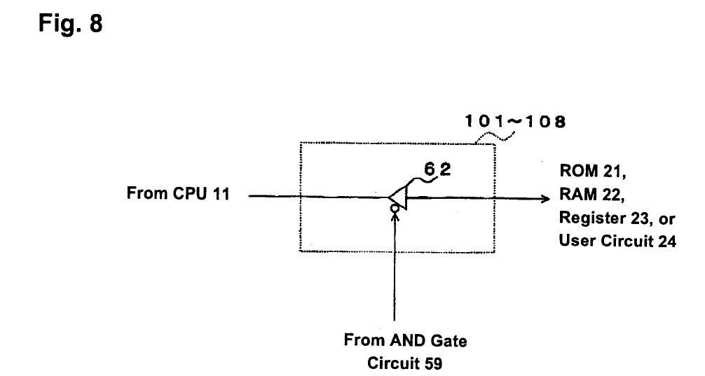

Also, in the first-third embodiments, the protect circuits 31-34 have the input/output buffers 51-58 (see FIG. 3). However, depending on the requirements, the protect circuits 31-34 may have output buffers 91 - 98 shown in FIG. 7, or the protect circuits 31-34 may have input buffers 101-108 shown in FIG. 8.

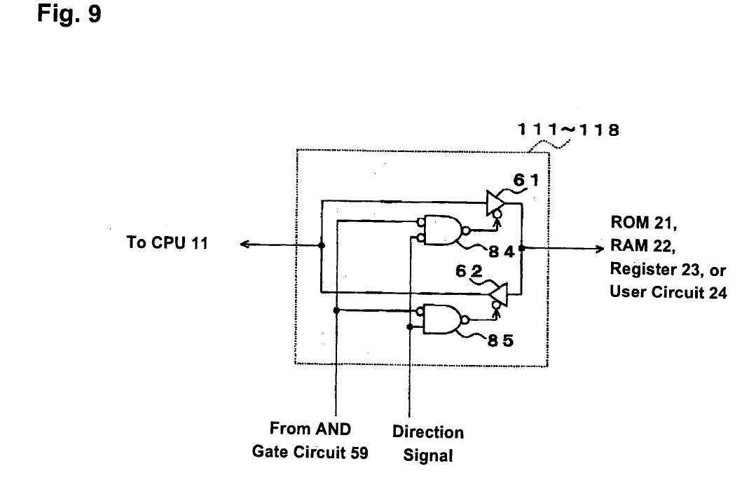

Also, the protect circuits 31-34 may have input/output buffers 111 -118 including buffers 61 and 62 and NAND gate circuits 84 and 85 shown in FIG. 9.

As described above, in accordance with the present invention, when a predetermined data or signal is inputted, internal data, programs or program insructions can be read. As a result, reading of internal data by a user who performs debugging of the software and preventing other users from reading the internal data can be readily realized.

What is claimed is:

1. A semiconductor device that is equipped with an operation processing circuit and M number (M is a natural number) of functional blocks having predetermined functions, and that, when connected to an external debug tool, sends data, programs or program instructions in the functional blocks to the debug tool, the semiconductor device comprising:
N number of first circuits that are respectively connected between a predetermined N number (N is a natural number smaller than M) of the functional blocks among the M number of functional blocks and the operation processing circuit, and that, in response to an instruction, transfer data, programs or program instructions between the N number of the functional blocks and the operation processing circuit;
a second circuit that, when connected to the debug tool, controls the operation processing circuit in response to an instruction from the debug tool, and instructs the N number of the first circuits not to transfer data, programs or program instructions between the N number of the functional blocks and the operation processing circuit; and
a third circuit that, upon receiving predetermined data or a signal, instructs the N number of the first circuits according to the predetermined data or signal to transfer data, programs or program instructions between the functional blocks and the operation processing circuit regardless of an instruction from the second circuit,
wherein the operation processing circuit, when not connected to the debug tool, transfers and receives data, programs or program instructions to and from the M number of the functional blocks to execute predetermined operations, and when connected to the debug tool, reads and transfers to the debug tool data, programs or program instructions in the N number of the function blocks through the N number of the first circuits.

2. A semiconductor device according to claim 1, wherein the third circuit receives a plurality of predetermined data or signals, and instructs individual ones of the N number of the first circuits according to the plurality of predetermined data or signals to transfer data, programs or program instructions between the functional blocks and the operation processing circuit, regardless of an instruction from the second circuit.

3. A semiconductor device according to claim 1, wherein the third circuit receives encoded data or signals, decodes the encoded data or signals, and instructs individual ones of the N number of the first circuits according to the decoded data or signals to transfer data, programs or program instructions between the functional blocks and the operation processing circuit, regardless of an instruction from the second circuit.

4. A semiconductor device according to claim 1, wherein the third circuit comprises a register, and when the register is accessed, instructs the N number of the first circuits to transfer data, programs or program instructions between the functional blocks and the operation processing circuit, regardless of an instruction from the second circuit.

5. A semiconductor device according to claim 4, and wherein the third circuit, when predetermined data is written in the register, instructs individual ones of the N number of the first circuits according to the data written in the register to transfer data, programs or program instructions between the functional blocks and the operation processing circuit, regardless of an instruction from the second circuit.

6. A semiconductor device according to claim 4, wherein the third circuit comprises a plurality of registers, and when the registers are accessed, instructs particular ones of the N number of the first circuits according to the registers accessed to transfer data, programs or program instructions between the functional blocks and the operation processing circuit, regardless of an instruction from the second circuit.

7. A semiconductor device according claim 4, wherein the third circuit is comprises a plurality of registers, and when predetermined data is written in any or all of the registers, instructs particular ones of the N number of the first circuits according to the registers accessed and the predetermined data written in the registers to transfer data, programs or program instructions between the functional blocks and the operation processing circuit, regardless of an instruction from the second circuit.

8. A semiconductor device according to claim 1, wherein the predetermined data or signal that is received by the third circuit is supplied from the operation processing circuit or from outside the semiconductor device.

9. A semiconductor device according to claim 4, wherein the register is accessed from the operation processing circuit or from outside the semiconductor device.

10. A semiconductor device according to claim 1, further comprising a fourth circuit that receives data in a predetermined protocol from outside the semiconductor device, and wherein the fourth circuit outputs the predetermined data or signal to the third circuit based on data received from outside the semiconductor device.

11. An in-circuit emulator equipped with a semiconductor device according to claim 1, and a debug tool that is connected to the operation processing circuit and the second circuit within the semiconductor device.
